(19) United States
(12) Patent Application Publication
(10) Pub. No.: US 2014/0278504 A1
(43) Pub. Date: Sep. 18, 2014

(54) Medical Research Technology Information Consortium

(71) Applicant: Mark M. BRAUER, San Antonio, TX (US)

(72) Inventor: Mark M. BRAUER, San Antonio, TX (US)

(21) Appl. No.: 14/214,126

(22) Filed: Mar. 14, 2014

Related U.S. Application Data
(60) Provisional application No. 61/851,849, filed on Mar. 14, 2013.

(51) Int. Cl. G06F 19/00; G06F 17/30

(52) U.S. Cl. CPC G06F 19/324; G06F 17/30477
USPC 705/2

(57) ABSTRACT

Systems and methods for communicating an accumulation of medical and healthcare research within an electronic nationwide medical research technology information consortium (MRTIC) housed at a centralized location. The manipulable electronic databases associated with the system function to respond to queries from both professionals and private individuals (patients) in a particular medical or healthcare field. The system operates to disseminate information and to identify areas where duplication of effort may be replaced by collaborative efforts. The information disseminated is non-proprietary in nature and serves primarily to identify rather than quantify current and past research efforts. The system therefore benefits broad categories of researchers, institutes, government organizations, sponsors, and patients.

### CROSS REFERENCES TO RELATED APPLICATIONS

This application claims the benefit under Title 35 United States Code §119(e) of U.S. Provisional Patent Application Ser. No. 61/851,849 filed Mar. 14, 2013, the full disclosure of which is incorporated herein by reference.

### BACKGROUND OF THE INVENTION

1. Field of the Invention

The present invention relates generally to digital electronic systems and databases for the storage, management and communication of medical and healthcare information. The present invention relates more specifically to systems and methods for identifying and coordinating common research efforts and information and for establishing collaborative paths through such digital networks, electronic data processing systems, and databases.

2. Description of the Related Art

Medical and/or healthcare research is known to be costly in terms of resources, including personnel, research team resources (professional and technical talent, management, and support staff), research facilities and space, research equipment, research materials, and time. Medical and healthcare research also places the assets and goodwill of its team at some public relations and market risk. A review of the current medical and healthcare research environment reveals that nearly all research entities and sponsors have established stand-alone, highly secretive sophisticated repositories for historical safety, protection of research records, and intellectual property. There is no single national database in existence at the researcher/laboratory or sponsor levels, to reduce, much less cross reference, the medical healthcare research data overload. There is however a legacy of abundant duplication in medical and healthcare research that could have been, and could now be, avoided in favor of new and worthy research facilitated by the paperless environment characterized by the present invention.

It is not uncommon for competitive research organizations that do not communicate with each other to be working on precisely the same medical or healthcare research, located within minutes of each other physically, but because they are sponsored by different philanthropies or are at different medical laboratories, are competing against each other without knowledge, devoting energies to the same research at the same time. This creates a very unhealthy economic model for the medical and healthcare industry. Duplication of talented human resources and expertise, facilities, time, material, money, as well as file rooms full of unnecessary, aging and, in some cases, combustible research data, the quantity of which is extreme and is further being aimlessly accumulated and wasted.

It would be desirable to have an open source electronic data processing and communications system that eliminated much of the medical and or healthcare research duplication, that could facilitate real time awareness of ongoing research by a simple, verified posting via a unique yet simple profile form or format. It would be desirable if such a system could provide this cross connectivity before such research is ready for market or journal publication.

### SUMMARY OF THE INVENTION

In fulfillment of the above objectives the present invention provides systems and methods for communicating the current “state of the science” in medical and healthcare research. The present invention provides such a novel, open source digital electronic system that has the potential to eliminate much of research duplication in the medical and healthcare fields and to provide such real time awareness of ongoing research by utilizing a verified posting based upon a single, simple profile form. The present system and method provide this awareness before specific research by specific research teams is necessarily ready for market or journal publication. By relating non-proprietary, initial information, the present system facilitates early, voluntary collaboration discussions and decisions, by researchers, donors, and/or institutes (collectively RDIs). Defined caches (see Drawing Figures discussed below) are tailored to categorize specific diseases, maladies, accidents, pharmaceuticals, devices, practices, processes and procedures. This tailoring of the databases facilitates and speeds up the direct focused contact without infringement or violation of trade secrets. Postings may be tied typically to, or accessed by, established healthcare organizations such as the One Health Initiative or the World Health Organization, to expand geometrically and instantaneously the search field carried out by any RDI member, government organization, or by the public. The systems and methods of the present invention are intended to be not-for-profit, and transparent to the public by uninterrupted electronic access. Given any medical or healthcare parameter (for example, “cancer”) the search paths used by the RDI member, government organization or public (open) would be identical.

### BRIEF DESCRIPTION OF THE DRAWINGS

FIG. 1 is a schematic block diagram showing the various database components (caches) organized under the system and method of the present invention.

FIG. 2 is a schematic flowchart showing the process of querying the database and obtaining answers and identifications of coordinated research utilizing the system and method of the present invention.

FIGS. 3A-3C are representative screenshots showing various embodiments and examples of the inquiry form that makes up the basis of all inquiries into the system that prompts not only answers regarding the query but also indications of coordinated and corresponding research.

FIG. 4 is a flowchart of the basic method of access to, and query of, the system and method of the present invention.

### DETAILED DESCRIPTION OF THE PREFERRED EMBODIMENTS

The search paths utilized in the system and method of the present invention are identical for any medical or healthcare parameter submitted by a researcher, donor, or institute member (RDIs), by a government organization, or by the public in an open search activity. The search path may generally be described as comprising a stimulus or input wherein the RDI, government organization or public (private citizen) has a specific medical or healthcare interest that is submitted to the proprietary system. The specific response or output generated by the system will comprise: (a) a complete review of related institutes; (b) a complete review of sponsors and donors; (c) a complete review of ongoing research; and (d) a complete review of original/member researchers.

A new entry (different from the open search path above) by a recognized, pre-coded member RDI is easily and automatically implemented by a secure system key and is protected simultaneously from contamination (or duplication, as noted below and in the system diagram). Two or more medical or healthcare researchers working for different institutes and supported by different donors are given their own unique posting by their own deterministic, particular, keyed and time-stamped access code. Such a posting, if close enough to appear to duplicate other system-identified research, would automatically be highlighted by the system. While the public user does not necessarily see the highlighting, it enables all those within the highlighted research teams to immediately consider communicating between and among themselves to compare strategies, continue on their own existing paths, or continue exploration of collaborative paths that might save or spread precious resources, enabling concerted use of special design and test expertise to significantly reduce real concept-to-market time and resulting customer (patient) costs. The present system also provides urgent access to medical and healthcare information in a rural disaster environment. For example, such information could be provided to official channels such as the Red Cross® or the Federal Emergency Management Agency (FEMA).

In summary, the system and method of the present invention support most medical and healthcare researchers, donors and institutes such as educational institutes, delivery government organizations, non-governmental organizations, clinics, hospitals, hospices, universities, nursing/triage units, the insurance industry, and the public at large. Such services are intended to be provided without profit to the system management organization.

Reference is made to FIG. 1, which provides a system and method block diagram disclosing the input/output access stream for the present invention. This access stream is a high-speed, two way, seamless pathway that is initiated by the inquirer's initial system entry. Using the examples discussed below, the user would immediately see drop down menus within the various established caches, enabling the inquirer to explore all of the top level information along that path, or to select any individual leg of the path for further analysis. Cross checking within the system and method of the present invention enables users to view all related process, procedural, prosthetic (medical device), and pharmaceutical developments from an up to date and open yet secure (read only) database, while in their own chosen research environment.

Reference is therefore made to the flow diagram in FIG. 1 which provides a block overview showing the basic structure of the system of the present invention and the various databases that are maintained and cross-referenced in the process of input and query by physicians, sponsors and the public. The system 10 is entered by physicians, sponsors and the public at entry portal 12 which directs the users to one of three primary caches. In the preferred embodiment of the present invention, three caches generally identify categories of medical or healthcare information that the user may be interested in. These are identified as the diseases cache 14, the maladies cache 16, and the injuries cache 18.

Each of the identified caches represent cross referenced databases, that while they may not contain the specific information, provide location and content information suitable to direct the user to answers to queries and/or potential collaborative efforts. The three identified caches are each connected to four specific research and development fields for that cache. In the preferred embodiment of the present invention, these four research and development fields include new processes 20, new procedures 22, new prosthetic and/or medical devices 24, and new pharmaceuticals 26. Within each of these fields are provided complete listings of the research and informational databases that have been constructed for the purposes of answering queries and coordinating research efforts.

Reference is next made to FIG. 2, which provides a general overview of the flow of information prompted by a query through the system and method of the present invention, to provide answers and coordinated research identification. In FIG. 2, the system repository 30 may be queried by a professional question or input 38, a sponsor question or input 40, or a public question 42. The system repository is a physical entity housing the database management and support staff for the system. The question or raw source electronic data proposed for entry (logging) within the proprietary system catalog made by a professional or sponsor (38 or 40) is accessible by identifying: (a) a uniquely assigned control number, (b) researcher name, (c) sponsor name, (d) disease, (e) operation, (f) pharmaceutical, or (g) prosthetic (medical device). Input is equally acceptable from a research or sponsoring agency. Secondary priority questions, such as made by the public 42, are available for processing after the professional and sponsor answers have been provided as time and channel capacity dictate.

Within the system repository 30, a number of functions occur. Management activity 32 occurs providing interface with public data entry and the physical upkeep of the system. Data entry technicians 34 provide profile validation, evaluation of entries, routine file maintenance, and file upkeep. Medical research technicians 36 provide interface with the medical community.

When queried as indicated above, system 30 provides output answers to professionals and sponsors 44, and to public and private citizens 46. While input is equally acceptable from a researcher or sponsoring agency as indicated above, high priority electronic or telephone professional response paths to professionals and sponsors 44 have querying priority over public/private questions or response paths 46.

Reference is next made to FIGS. 3A-3C which provide a number of examples of preferred embodiments for the single unitary form utilized for public inquiry of the system of the present invention. Utilizing one of these variations on this profile and query form, the public may access voluntarily posted research by defining such research according to the specific fields.

A simplified form is shown in FIG. 3A. Field 1 in the system form contains a control or access ID number (12 characters once registered and assigned). Field 2 presents a succinct title of the research. Field 3 identifies a first type of domain sector comprising procedure, process, prosthetic (or medical device), or pharmaceutical. Field 4 identifies a second type of domain sector comprising disease, malady, or injury. Field 5 provides the research, donor or institute (RDI) contact information where at least one of these will be open posted. This RDI contact information preferably contains: (a) the researcher's name (and address, if provided for open access); (b) the donor's name and address (as above noted); (c) the institute/sponsor, granting agency, or insurance company (again with address as above noted); and (d) the preferred point of contact.

Once any combination of the above system profile entry fields is accepted and completed to the user's satisfaction, the inquirer submits the entry to initiate completion of a given search. FIGS. 3A-3C are therefore representative screenshots showing various embodiments and examples of the inquiry form that makes up the basis of all inquiries into the system, and that prompts not only answers regarding the query, but also flags indications of coordinated and corresponding research. The fundamental fields under the standardized system profile, described by the examples in FIGS. 3A-3C, preferably comprise the following:

i. Control/Access Number—Once validated, research is registered and given an identification number.

ii. Title—Chosen by the researcher or the researcher's laboratory or sponsor. This is often the hypothesis of the research.

iii. Key Words—That characterize the research.

iv. Researchers' Names.

v. Researcher's Organization Name—Along with location information regarding where the research is being conducted.

vi. Sponsors' or Donors' Names—If different from the researcher or the researcher's organization.

vii. Preferred POC—The point of contact (which, when given, preferably must repeat at least one of the above names and/or organizations and will contain any and all contact data as approved by the user (physical email, web address, phone or fax numbers, etc.).

viii. Research Initiation Date—Based on specific field and focus.

ix. Research Completion Date—Unless ongoing.

x. Results—If any specific results have yet been realized and reduced to summary.

Preferably, to gain access the system will require that a public inquirer must enter one of three access letters (alpha codes) identified below, after which drop down menus direct the user to the exact page of interest. Preferably these access areas include a) procedure, process, prosthetic (medical device), or pharmaceutical; b) sponsor, donor, granting agency, or insurance company; or c) disease, malady or injury (for example, slips, trips or falls as options under injury).

The example provided in FIG. 3C is a typical (hypothetical) application of the system and method of the present invention. This example utilizes a typical medical or healthcare event, sometimes characterized as a slip, trip or fall (STF), action and injury. A researcher, interested in this type of injury research, with or without a sponsor, may interrogate the system of the present invention, utilizing the above described profile format. Use of the profile tool helps minimize or even eliminate duplicate research and provides access to professionals and the public alike to view the information generated by the system interrogation. With only the information provided in the profile, a system user will immediately have informational access to live, slip, trip, and fall research routes across a wide spectrum of keywords, characteristics, and research efforts.

In the example shown, these keywords may include causes of the injury, efforts to prevent such injuries, protections against such injuries, individuals researching and operating in the field of such injuries, and recent efforts to address overall the medical and healthcare ramifications of such injuries. A researcher or sponsor providing the interrogation profile would be alerted to the possibility of duplication of research at this point, in addition to warnings if a keyword is sensed during validation or the interrogation process that flags and double checks for duplication mitigation.

FIG. 4 is a flowchart of the basic method of access to, and query of, the system and method of the present invention. Step 100 provides the initiation of the user entry into the system database. Step 102 invites the user to generally identify the purpose of the access. This step primarily distinguishes between access by a researcher and access by a patient or someone in the general public. Step 104 queries whether the user is a professional (researcher, sponsor, institute, etc) or an unaffiliated member of the public. If the access is by a professional then the process proceeds to Step 106 where validation and identification occur to allow expanded access to the system. Step 108 queries whether the professional user is accessing for the purpose of creating new data entries or for querying the database themselves. If entering new data the process proceeds to Step 110 which runs the routine to allow data entry and upload.

Step 112 operates for both professional users and private users to complete one version of the profile forms discussed above. Step 114 (also occurring on the profile form) invites identification of the domain sector of interest and/or the entry of standard medical or healthcare codes associated with the field of interest. The user then identifies the query at Step 116 and submits the same to query the database at Step 118. The system processes the request/query and formulates an answer. It is at this stage that specific algorithms identify overlapping research areas and highlight such areas to professional users as described above. The process finishes at Step 120 where the results are displayed to the user, primarily in summary form with relevant contact information for further inquiry.

Upon completion of the system interrogatories, and beyond the basic medical and healthcare data provided, three additional benefits of the system and method of the present invention include: (a) providing the identity of duplicate research to all potential researchers, research organizations, laboratories, sponsors and insurers in a non-confrontational environment; (b) enabling all proponents the voluntary ability to discuss, review, and decide on the validity of such duplication or the need for other directions; and (c) as described above, determine that other directions are more beneficial such as going it alone, ceding the research to one or more other actors or entities, or identifying the potential for collaboration and partnering.

Additionally the system and method of the present invention may be seen to provide the creation of a virtual table-of-the-elements-like search engine that gives researchers and sponsors a graphical, three-dimensional view of where holes exist in the research for a particular field. The research world can then focus on research voids not identified beforehand, in an open, scalable and friendly architecture.

A primary goal of the system and method of the present invention is to place all medical and healthcare sponsored research into a real time accessible database, identifiable by a single electronic address (URL). The system helps to eliminate duplication or at least minimize duplication of efforts so that the results of medical and healthcare research can be expedited. The open clearinghouse format facilitates industry-wide access to medical and healthcare offices, hospitals, pharmacological and medical device manufacturers, government entities, independent researchers and research facilities, universities, sponsors and insurance companies, studying a full range of healthcare maladies and conditions. The system is designed to be established as a not for profit single point of contact system that is secure, transparent and non-proprietary. The system provides for validated and publicly accessible information for purposes of ready access of the information and the cross connection of groups of individuals and groups working towards common research goals.

Once duplication in research efforts is exposed, the system of the present invention facilitates having research entities and/or sponsors join forces on any particular research due to the mutual betterment of all of the entities and the public. This is achieved in ways that neither of the entities, nor any facility could have succeeded in alone. In addition, the newly brought to light research efforts are more visible and organized in comparison with the past, such that a symbiosis occurs, accelerating the progress of research. Although individuality in research channels will remain, the new overview provided to the entities concerned by the present invention will disclose most needless duplication.

Through the use of the system and methods of the present invention, the symbiosis of researcher, sponsor, laboratory and public, with respect to a given catalogued piece of research, is shown in the stimulus/organism/response model of FIG. 2 discussed above. In this proprietary system diagram, the centerpiece represents the human electronic database interface at which the three levels of interaction take place. The actual research data are stored as read-only data and electronic media and are easily updated by individuals tasked with handling and maintaining the system and method of the present invention.

Rather than depending on the random directions often associated with medical and healthcare research, the present invention proactively and intrinsically exposes duplication across as many entities as may exist. This facilitates a new, voluntary, three way choice for all such entities, where no choice was even visible previously. Once identified by the system, each of the duplication proponents is given the voluntary opportunity to choose its own route, namely (a) continue to go it alone, judging that the particular research deserves its own difference in approach, (b) cancel the particular research, leaving the other actors or entities to continue, perhaps now in concert, or (c) combine any and all aspects of the research such that the unique capabilities of all of the individual actors yields individual focus, bringing each of the actors a faster, stronger, more viable, collaborative, entrepreneurial result, ultimately yielding a better medical healthcare end product. The resulting synergy derived in part from this approach enables special tools from various, unique medical and healthcare sources to combine in new technically richer cooperative research ventures not anticipated before, as opposed to the prior environment of random, often duplicative research.

The system and method of the present invention balance security and transparency in providing database access. To log onto or apply to the read only system database, no proprietary medical or healthcare information is required to be input and there is no database component for proprietary information to be stored. Use of a simple, interactive system profile (the world view of the proprietary system) is completed. This profile form, shown by examples generally in FIGS. 3A-3C, confirms that the data stored is completely open and transparent, universally and constantly available to anyone with electronic data processing capabilities and network access.

The not for profit basis for the system and method of the present invention enables medical and healthcare research to gainfully expand without the usual, front end drain of profit taking, while reducing the prior level of individual actor detailed and in depth competition sensitive record keeping, as well as the usual administrative costs. The system of the present invention pays for itself by reinvesting the above credits along with reduced research duplication costs, gains from new cooperative research ventures, and improved business efficiencies including reduced legal industrial espionage costs. These savings are turned into real research benefits enabling the industry and profession to provide the public with more timely and effective medical research and healthcare results. Further economic benefits accrue by housing the system within major medically involved university environments, enhancing both the medical and healthcare fields and hands on computer software education and training with such experience.

The system and method of the present invention expand the medical and healthcare sponsor and support base by facilitating open exposure and transparency to the top levels of research by avoiding even the initial potential for duplication. Further, the system facilitates such openness by voluntarily reducing avoidable duplication. Through the research engine, the broad view identification effectively identifies new avenues and opportunities for research and sponsorship, and its new availability makes it easier for researchers and sponsors to recognize real, necessary research earlier (the holes in the research for a specific field). Furthermore, as in the hypothetical example given above, a potential sponsor becomes aware of an existing sponsor of the research, it might inspire the potential sponsor's entry into the research stream as a new additional donor or facilitator.

Combining the effects of the strategies of the system and method of the present invention into a wide range of tests and simulations will gradually provide faster data centered results and more complete responses to medical healthcare research queries and requests. Initially, the one major objective of the present invention will be to minimize, if not eliminate, the vast amount of medical healthcare research duplication. The concepts involved have developed into a microsecond response repository, capable of real time quick answers to queries. A secondary benefit resulting from this implementation is a medical and healthcare research engine that is more efficient, accurate and complete based upon its focus. The system development plan should proceed on a national, secure, validated, not for profit, and open basis, for medical and healthcare research data.

In summary, the present invention provides database accessibility in a non-political, voluntary medical and healthcare researcher selected program environment. The system is run by and preferably housed within leading national universities in order to minimize costs, maintain its non-profit status, and to profit the maximum return on investment. The system should be validated by major medical and healthcare research executives and professionals. The system will provide a first of its kind in the form of a national level medical and healthcare research clearinghouse. It will provide a public access repository and database available at all times.

A potential initial focus of a medical field within which extensive research is ongoing could be the cancer research field, including all related diseases, maladies and injuries. The database (both initially and long term) will include practices, procedures, pharmaceuticals, and prosthetics and medical devices. Although the specific location of the centralized database is not critical, a preference should be given to geographically central locations that already have established medical and healthcare research facilities.

Although further design and funding of the system would be required prior to broad implementation, many acts preliminary to operational functionality can be implemented immediately. These initial steps in the overall process will redirect research overlaps and redundancies into realistic and time critical medical and healthcare products and processes. The system will provide a real time, one-stop-shop for medical healthcare research. The systems and methods will facilitate parallel, multipronged directions to update medical and healthcare technology, and capture archival data, whether complete or not. The services will be provided in conjunction with all medical professionals, their outreach and collaboration efficiencies. It will be available to the public and be totally transparent, i.e. without any private proprietary information. The transparency of the database dictates that simple (sterile) standard listings that only disclose open research and identity parameters be utilized. The system should provide notice that no proprietary or other restricted intellectual property information is taken or stored by the system. The simple network access should be automated, verified and validated and updated on a constant basis. Once again, an appropriate analogy for the systems and methods established by the present invention is a “periodic chart” for research, i.e. a search engine with which to promote filling in the gaps in medical and healthcare progress.

Although the present invention has been described in conjunction with certain defined network structures and databases, those skilled in the art will recognize that the basic elements of the system and method could be configured alternately based upon specific fields of research and/or specific institute reporting structures. The system and method of the present invention is however tied directly to the medical and healthcare research field as this field provides unique problems and issues for researchers, sponsoring organizations, government organizations and the general public. The system and method of the present invention are directed to solving the problems associated with such medical and healthcare research information and making it accessible to the public and to researchers and organizations that might otherwise be duplicating their efforts.

I claim:

1. A system for communicating medical and healthcare information to private patients and professionals in the field, the system comprising:
(a) a manipulable first digital electronic database having medical and healthcare information stored therein, the information in the form of past, current, and planned research, the information organized by domain sectors;
(b) a manipulable second digital electronic database having user information associated with researchers, sponsors, and private individuals accessing the first digital electronic database;
(c) an electronic data processor connected to the first and second digital electronic databases and operable to process queries from users of the databases, the electronic data processor operating a search engine based on queries and configured to identify overlapping research efforts made by distinct researchers;
(d) a digital electronic network server connecting the electronic data processor to the Internet to provide access to the first and second digital electronic databases from disparately located users.
